(19) United States
(12) Patent Application Publication
(10) Pub. No.: US 2004/0156065 A1
(43) Pub. Date: Aug. 12, 2004

(54) Image forming apparatus, image forming system, processing execution method by image forming apparatus, and processing execution program for image forming apparatus

(75) Inventor: Hidenobu Suzuki, Numazu-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/360,851

(22) Filed: Feb. 10, 2003

(51) Int. Cl. G06F 3/12; G06F 15/00; G06F 17/60

(52) U.S. Cl. 358/1.13; 358/1.15; 705/10

(57) ABSTRACT

An image forming apparatus that allow a user to choose to display or not to display information obtained from a server, e.g. an advertisement, which is to be displayed on a screen of the image forming apparatus, according to the user's own will is provided.

With a multi-function image forming system 100 according to the present invention, the user can give instructions to an image forming apparatus 10 according to his or her own circumstances. For example, when the user has no time to spare, he or she can select non-consideration paying processing in which the user uses only the image formation function. When the user has time to spare and wants to receive an economic consideration, he or she can select consideration paying processing in which the user gives user information. At the consideration paying processing step, bilateral data transfer is performed between the image forming apparatus 10 and the server 30. For example, a questionnaire provided by an information-gathering company is sent from a questionnaire processing unit 31 to the image forming apparatus, and user information is collected. A coupon as a consideration is issued from a coupon issuing processing unit 33 to the user.

### BACKGROUND OF THE INVENTION

1. Field of the Invention

The present invention relates to an image forming apparatus, an image forming system, a processing execution method by an image forming apparatus, and a processing execution program for an image forming apparatus. More particularly, the present invention relates to an image forming apparatus having an MFP (Multi-Function Peripheral) function and provided with a large-screen display, which is connectable to a server through a network.

2. Description of the Related Art

A conventional image forming apparatus, e.g. a certain type of MFP, asks a user a question through an on-screen advertisement, collects necessary information from the user's answer, pays the user some consideration for the information, and utilizes the collected information in accordance with a particular purpose, thereby making use of the function of the MFP even more effectively.

The above-described conventional image forming apparatus is not provided with the function of allowing the user to choose freely not to respond to an advertisement displayed on the screen of the image forming apparatus when he or she does not want to see the on-screen advertisement or answer an asked question or the like, or when the user wants to perform image formation (copying) immediately without responding to the on-screen advertisement. Therefore, some users may feel considerable stress.

### SUMMARY OF THE INVENTION

The present invention was made to solve the above-described problems. Accordingly, an object of the present invention is to provide an image forming apparatus, an image forming system, a processing execution method by an image forming apparatus and a processing execution program for an image forming apparatus that allow a user to choose to display or not to display information provided by a server, which is to be displayed on a screen of the image forming apparatus, according to the user's own will.

To attain this purpose, the present invention provides an image forming apparatus connectable to a server through a communication line. The image forming apparatus has a mode selection unit capable of selectively setting a first mode of executing processing using information obtained from the server and processing for image formation, and a second mode of executing processing for image formation without executing processing using information from the server. The image forming apparatus further has a processing execution unit for executing processing according to a mode set by the mode selection unit.

Further, the image forming apparatus according to the present invention has a display unit for providing an operation screen for a user to operate to execute processing according to a mode set by the mode selection unit.

Further, the image forming apparatus according to the present invention is arranged such that, in the first mode, information collecting operation data for collecting information entered by the user as user information is displayed on the display unit.

Further, the image forming apparatus according to the present invention is arranged such that when the first mode is selected, consideration paying processing for paying the user a consideration for the selection of the first mode is performed.

In the image forming apparatus according to the present invention, the processing using information obtained from the server includes at least one of advertisement providing processing for providing an advertisement and questionnaire providing processing for providing a questionnaire to which the user is asked to respond.

In the image forming apparatus according to the present invention, the processing using information obtained from the server includes advertisement providing processing for providing an advertisement and questionnaire providing processing for providing a questionnaire to which the user is asked to respond, in such a manner that either of the advertisement providing processing and the questionnaire providing processing can be selected.

Further, the image forming apparatus according to the present invention has a processing switching unit capable of switching the first mode to the second mode during execution of processing in the first mode.

In addition, the present invention provides an image forming apparatus connectable to a server through a communication line. The image forming apparatus has a first display unit capable of displaying operation data for image formation processing, and a second display unit capable of displaying information obtained from the server.

In the image forming apparatus according to the present invention, the second display unit displays information collecting operation data for collecting information entered by a user as user information.

In the image forming apparatus according to the present invention, the second display unit comprises an option display panel detachably provided on the body of the image forming apparatus.

In addition, the present invention provides an image forming apparatus connectable to a server through a communication line. The image forming apparatus has non-consideration paying processing execution means for executing non-consideration paying processing in which a user is allowed to use only an image formation function and paid no consideration, and consideration paying processing execution means for executing consideration paying processing in which the user is allowed to use the image formation function, and in which the consideration paying processing execution means receives user information and pays the user a consideration for the user information. The image forming apparatus further has selection means for making a selection between the processing executed by the non-consideration paying processing execution means and the processing executed by the consideration paying processing execution means.

In the image forming apparatus according to the present invention, the consideration paying processing execution means reads data for the consideration paying processing from the server to execute the processing.

In addition, the present invention provides an image forming system having a server and an image forming apparatus connectable to the server through a communication line. The image forming apparatus has a mode selection unit capable of selectively setting a first mode of executing processing using information obtained from the server and processing for image formation, and a second mode of executing processing for image formation without executing processing using information from the server. The image forming apparatus further has a processing execution unit for executing processing according to a mode set by the mode selection unit. The server has an information collecting data transmission unit for transmitting data for information collection in response to a request from the image forming apparatus. The server further has a user information reception unit for receiving the user information transmitted from the image forming apparatus.

In addition, the present invention provides a processing execution method by an image forming apparatus connectable to a server through a communication line. The processing execution method has a mode selection step of allowing a selection between a first mode of executing either processing for performing advertisement using information obtained from the server or processing for collecting information from a user and also executing processing for image formation, and a second mode of executing processing for image formation without executing processing for performing advertisement using information obtained from the server or processing for collecting information from the user. The processing execution method further has a processing execution step of executing processing using information obtained from the server when the first mode is selected at the mode selection step.

In addition, the present invention provides a processing execution program for executing processing by an image forming apparatus connectable to a server through a communication line. The processing execution program has a mode selection step of allowing a selection between a first mode of executing either processing for performing advertisement using information obtained from the server or processing for collecting information from a user and also executing processing for image formation, and a second mode of executing processing for image formation without executing processing for performing advertisement using information obtained from the server or processing for collecting information from the user. The processing execution program further has a processing execution step of executing processing using information obtained from the server when the first mode is selected at the mode selection step.

### DESCRIPTION OF THE DRAWINGS

FIG. 1 is a block diagram showing an embodiment of an image forming system according to the present invention.

FIG. 2 is a block diagram showing the arrangement of an image forming apparatus according to the present invention.

FIG. 3 is a flowchart for explaining the operation of the multi-function image forming system shown in FIG. 1.

FIG. 4 is a block diagram showing the arrangement of an image forming apparatus according to a second embodiment of the present invention.

### DESCRIPTION OF THE PREFERRED EMBODIMENTS

Embodiments of the present invention will be described below with reference to the accompanying drawings.

First Embodiment:

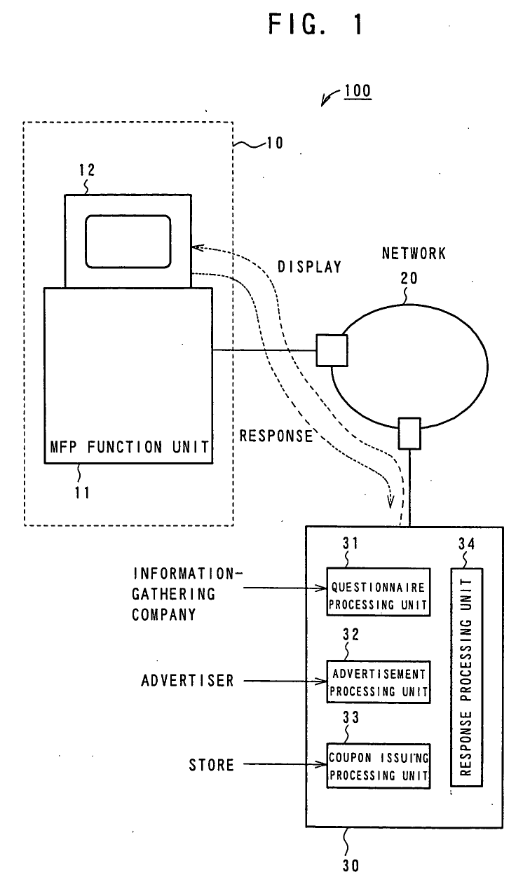

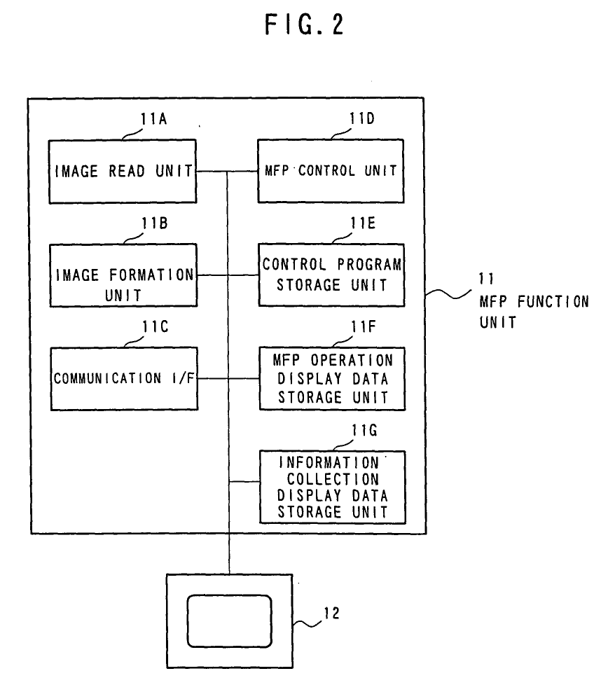

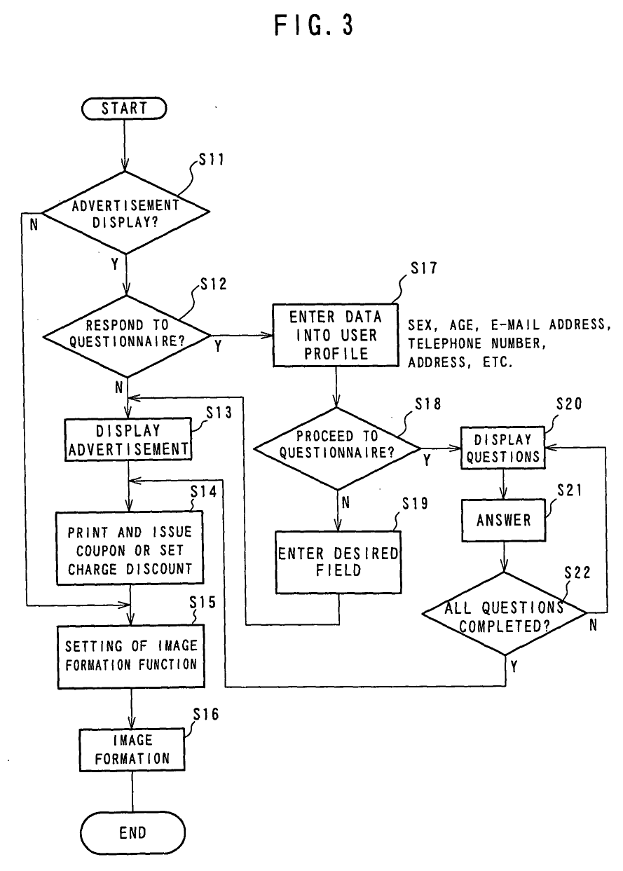

FIG. 1 is a block diagram showing an embodiment of an image forming system according to the present invention. FIG. 2 is a block diagram showing the arrangement of an image forming apparatus shown in FIG. 1. FIG. 3 is a flowchart for explaining the operation of the image forming system shown in FIG. 1. An image forming system 100 in FIG. 1 has an image forming apparatus (MFP) 10, a network 20, and a server 30. The image forming apparatus 10 has an MFP function unit 11 and a large-screen operation panel 12. The server 30 has a questionnaire processing unit 31, an advertisement processing unit 32, a coupon issuing processing unit 33, and a response processing unit 34.

The image forming apparatus 10 shown in FIG. 1 is capable of image formation (copying) by the function of the MFP function unit 11 and also capable of performing data transmission or telephony through the network 20 as well as capable of displaying a necessary image on the large-screen operation panel 12. In particular, the image forming apparatus 10 can take in information relating to advertisement or the like from the server 30 through the network 20 at the request of a user of the image forming apparatus 10 and presents the information to the user by using the large-screen operation panel 12. A more detailed arrangement of the image forming apparatus is shown in FIG. 2. The image forming apparatus 10 has an image read unit 11A for scanning an image to obtain electronic data; an image formation unit 11B for forming an image from the electronic data; a communication interface 11C for connecting the image forming apparatus 10 to a communication line, e.g. a telephone line or the internet; a control unit (MFP control unit) 11D for the image forming apparatus 10; a control program storage unit 11E for storing programs to be executed by the control unit 11D; an MFP operation display data storage unit 11F for storing display data for operating the image forming apparatus 10; an information collection display data storage unit 11G for temporarily storing information obtained from the server 30 to present an advertisement to the user and to perform questionnaire processing; and a panel display unit (large-screen operation panel 12) for performing operation display for executing image formation processing and also performing advertisement display and questionnaire operation display for executing questionnaire processing. It should be noted that the large-screen operation panel 12 also constitutes a selector/switching unit for making a selection between modes (described later) and for switching between processing operations, for example, switching the questionnaire processing as selected to the image formation processing in the middle of the questionnaire processing.

The questionnaire processing unit 31 of the server 30 previously stores questionnaires that information-gathering companies or the like wish to submit, and sends a stored questionnaire to the image forming apparatus 10 on the basis of a user's selection from the image forming apparatus 10, whereby it is possible to ask the user of the image forming apparatus 10 to answer the questionnaire. The advertisement processing unit 32 previously stores advertisements from advertisers. The advertisement processing unit 32 classifies types of business to which advertisements belong according to fields of business and stores advertisements according to the fields of business. When it is requested to provide an advertisement from the image forming apparatus 10, the advertisement processing unit 32 can select an advertisement falling in the requested field from the stored advertisements and send the selected advertisement to the image forming apparatus 10.

The coupon issuing processing unit 33 can issue a coupon from the image forming apparatus 10 as a consideration for the action of the user of the image forming apparatus 10 when he or she viewed the above-described advertisement or responded to the questionnaire. The face value of the coupon has previously been set by a notice from stores where the image forming apparatus 10 is installed or from a management company that supervises these stores. The response processing unit 34 collects information from the image forming apparatus 10 in association with the operation of the questionnaire processing unit 31, etc. and stores the collected information so that it can be provided to an information-gathering company or the like in the form of collected and classified information.

Next, the operation of the foregoing multi-function image forming system 100 will be described with reference to FIG. 2. At the time of initialization, the MFP function unit 11 (MFP control unit 11D) of the image forming apparatus 10 in FIG. 1 instructs the large-screen operation panel 12 to display a frame inquiring whether or not to perform a display concerning advertisement. The user of the image forming apparatus 10 gives an instruction on whether or not to perform a display concerning advertisement besides image formation (copying) by using keys provided on the MFP function unit 11 or an icon displayed on the large-screen operation panel 12. The MFP function unit 11 judges whether or not the given instruction is to perform a display concerning advertisement (S11).

If it is judged at step S11 that the given instruction is to perform a display concerning advertisement, the MFP function unit 11 inquires of the user whether he or she will respond to data collection questions concerning him or her (e.g. a questionnaire) or the user wants to simply view an advertisement, and judges whether the user will respond to data collection questions or wants to simply view an advertisement (S12). If it is judged at step S12 that the given instruction means that the user wants to simply view an advertisement, the MFP function unit 11 receives an applicable advertisement from the advertisement processing unit 32 through the network 20 and displays it on the panel 12 (S13). Then, the MFP function unit 11 issues, for example, a coupon as a consideration for the user's viewing the advertisement or performs setting of a charge discount (S14). In this case, it is preferable that the response processing unit 34 should store the number of times at which the display of the advertisement has been selected to report it to the advertiser. Thereafter, the image forming apparatus 10 accepts various settings of the image formation function (copying function) (S15) and performs image formation according to the accepted settings (S16) to complete a series of processing operations for image formation.

If it is judged at the above-described step S11 that the given instruction is not to perform a display concerning advertisement, the process shifts to step S15. Thus, the process immediately shifts to the operation for image formation. If it is judged at step S12 that the given instruction means that the user will respond to data collection questions concerning him or her, the MFP function unit 11 instructs the panel 12 to display a user profile frame and asks the user to enter items that an advertiser or an information-gathering company needs, e.g. sex, age, e-mail address, telephone number, and address (S17). Thereafter, the MFP function unit 11 inquires of the user whether or not he or she will respond to a more detailed questionnaire, and judges whether the user's answer is YES or NO (S18). If the user answers to the effect that he or she will not respond to a detailed questionnaire, the MFP function unit 11 asks the user which field his or her desired advertisement is in to shift to the advertisement display step, and receives a selected field (Sl9). Then, the process shifts to step S13 to display an advertisement in the selected field.

If the user answers to the effect that he or she will respond to a detailed questionnaire at step S18, the MFP function unit 11 instructs the large-screen operation panel 12 to display questions for a detailed questionnaire (S20). When an answer is obtained (S21), the MFP function unit 11 judges whether or not all the questions have been completed (S22). If all the questions have not yet been completed, the process returns to step S20. If all the questions have been completed, the process shifts to step S14. In this case, it is preferable that the response processing unit 34 should store the contents processed at step S18 and the following steps as well as the contents processed at step S13 and the following steps to report them to the advertiser, etc. Even when the user views an advertisement or responds to an questionnaire at the above-described steps, he or she can give up the right to receive a consideration in the middle of viewing the advertisement or responding to the questionnaire and proceed to step S15 to execute the operation for image formation immediately.

Second Embodiment:

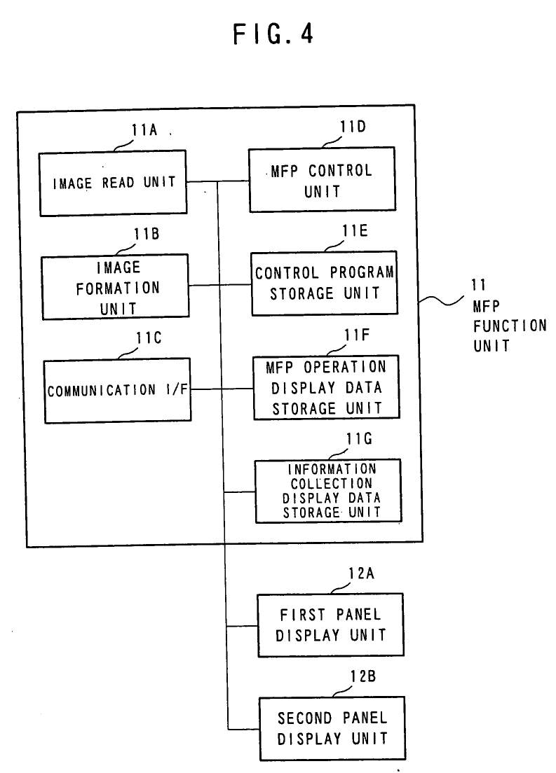

The foregoing first embodiment uses a single large-screen operation panel to perform advertisement display and questionnaire display as well as operation display for image formation processing. However, the image forming apparatus (MFP) may have two display panels, as shown in FIG. 4, e.g. a large-screen operation panel (first panel display unit) 12A and an option display unit (second panel display unit) 12B, which is a sub-operation panel. In this case, for example, the first panel display unit 12A displays an operation method for image formation processing, and the second panel display unit 12B performs advertisement display and questionnaire display by using information obtained from the server 30. For example, the processing operations at steps S11 to S14 and steps S17 to S22 in FIG. 3 are executed by using the second panel display unit. It should be noted that constituent elements in FIG. 4 that are identical or equivalent to those in FIG. 1 are denoted by the same reference numerals, and a description thereof is herein omitted. The arrangement of the second embodiment allows the user to perform image formation processing while visually recognizing advertisement display or executing questionnaire processing, for example. Thus, temporal efficiency can be increased. Meanwhile, on the server operator side, the advertisement or information collection can be performed for more users. Thus, the operating efficiency of the sever can be increased.

As has been detailed above, the present invention allows the user of the image forming apparatus to give instructions to the image forming apparatus according to his or her own circumstances. For example, when the user has no time to spare, he or she can select non-consideration paying processing in which the user uses only the image formation function. When the user has time to spare and wants to receive an economic consideration, he or she can select consideration paying processing in which the user gives user information. Thus, the user can use the image forming apparatus according to the user's own will. Therefore, the user is less likely to feel stress.

Further, when the consideration paying processing step is selected by the user in the foregoing embodiment, the image forming apparatus reads the consideration paying processing step from the server and executes it. Accordingly, even if a large number of image forming apparatuses are located through a network, the operation for the program concerning the consideration paying processing step needs to be performed only for the server, which is efficient.

Further, the consideration paying processing is shiftable to the non-consideration paying processing in the middle of execution of the consideration paying processing with giving up the right to receive a consideration. Accordingly, it is easy to switch between processing operations in a case where it becomes necessary to hasten to use the image formation function in the middle of execution of the consideration paying processing.

What is claimed is:

1. An image forming apparatus connectable to a server through a communication line, said apparatus comprising:
a mode selection unit capable of selectively setting a first mode of executing processing using information obtained from said server and processing for image formation, and a second mode of executing processing for image formation without executing processing using information from said server; and
a processing execution unit for executing processing according to a mode set by said mode selection unit.

2. An image forming apparatus according to claim 1, further comprising:
a display unit for providing an operation screen for a user to operate to execute processing according to a mode set by said mode selection unit.

3. An image forming apparatus according to claim 2, wherein, in said first mode, information collecting operation data for collecting information entered by the user as user information is displayed on said display unit.

4. An image forming apparatus according to claim 1, wherein when said first mode is selected, consideration paying processing for paying a user a consideration for selection of said first mode is performed.

5. An image forming apparatus according to claim 1, wherein the processing using information obtained from said server includes at least one of advertisement providing processing for providing an advertisement and questionnaire providing processing for providing a questionnaire to which a user is asked to respond.

6. An image forming apparatus according to claim 1, wherein the processing using information obtained from said server includes advertisement providing processing for providing an advertisement and questionnaire providing processing for providing a questionnaire to which a user is asked to respond, in such a manner that either of the advertisement providing processing and the questionnaire providing processing can be selected.

7. An image forming apparatus according to claim 1, further comprising:
a processing switching unit capable of switching said first mode to said second mode during execution of processing in said first mode.

8. An image forming apparatus connectable to a server through a communication line, said apparatus comprising:
a first display unit capable of displaying operation data for image formation processing; and
a second display unit capable of displaying information obtained from said server.

9. An image forming apparatus according to claim 8, wherein said second display unit displays information collecting operation data for collecting information entered by a user as user information.

10. An image forming apparatus according to claim 8, wherein said second display unit comprises an option display panel detachably provided on a body of said image forming apparatus.

11. An image forming apparatus connectable to a server through a communication line, said apparatus comprising:
non-consideration paying processing execution means for executing non-consideration paying processing in which a user is allowed to use only an image formation function and paid no consideration;
consideration paying processing execution means for executing consideration paying processing in which the user is allowed to use the image formation function, and in which said consideration paying processing execution means receives user information and pays the user a consideration for the user information; and
selection means for making a selection between the processing executed by said non-consideration paying processing execution means and the processing executed by said consideration paying processing execution means.

12. An image forming apparatus according to claim 11, wherein said consideration paying processing execution means reads data for said consideration paying processing from said server to execute said processing.

13. An image forming system comprising:
a server; and
an image forming apparatus connectable to said server through a communication line;
wherein said image forming apparatus includes:
a mode selection unit capable of selectively setting a first mode of executing processing using information obtained from said server and processing for image formation, and a second mode of executing processing for image formation without executing processing using information from said server; and
a processing execution unit for executing processing according to a mode set by said mode selection unit;
said server including:
an information collecting data transmission unit for transmitting data for information collection in response to a request from said image forming apparatus; and
a user information reception unit for receiving said user information transmitted from said image forming apparatus.

14. A processing execution method by an image forming apparatus connectable to a server through a communication line, said method comprising:
a mode selection step of allowing a selection between a first mode of executing either processing for performing advertisement using information obtained from said server or processing for collecting information from a user and also executing processing for image formation, and a second mode of executing processing for image formation without executing processing for performing advertisement using information obtained from said server or processing for collecting information from the user; and
a processing execution step of executing processing using information obtained from said server when the first mode is selected at said mode selection step.

15. A processing execution program for executing processing by an image forming apparatus connectable to a server through a communication line, said program comprising:
a mode selection step of allowing a selection between a first mode of executing either processing for performing advertisement using information obtained from said server or processing for collecting information from a user and also executing processing for image formation, and a second mode of executing processing for image formation without executing processing for performing advertisement using information obtained from said server or processing for collecting information from the user; and
a processing execution step of executing processing using information obtained from said server when the first mode is selected at said mode selection step.
